(19) United States
(12) Patent Application Publication
(10) Pub. No.: US 2022/0261913 A1
(43) Pub. Date: Aug. 18, 2022

(54) SYSTEMS AND METHODS FOR CREATING AND MANAGING COLLATERALIZED MUNICIPAL LOAN OBLIGATIONS

(71) Applicant: 2GenPen LLC, Morristown, NJ (US)

(72) Inventors: Laurence H. Wadler, Morristown, NJ (US); Bailu Pan, New York, NY (US)

(21) Appl. No.: 17/221,939

(22) Filed: Apr. 5, 2021

Related U.S. Application Data
(60) Provisional application No. 63/148,771, filed on Feb. 12, 2021.

(51) Int. Cl. G06Q 40/06; G06Q 40/02; G06Q 20/10

(52) U.S. Cl. CPC G06Q 40/06; G06Q 20/102; G06Q 40/02

(57) ABSTRACT

Systems and methods of managing distribution of income from a portfolio of financial assets are described. A debt service payment is received from the portfolio of financial assets and a determination of whether a fund benefitted by the portfolio of financial assets meets a target actuarial value is made. If the fund benefitted by the portfolio of financial assets meets the target actuarial value, the debt service payment is distributed to investors in the portfolio of financial assets. If the fund benefitted by the portfolio of financial assets does not meet the target actuarial value, a principal deflection mechanism is activated. A deferrable principal payment is calculated based on a difference between the present and the target actuarial values of the fund. The deferrable principal payment is distributed to the benefitted fund and the remaining debt service payment is distributed to the investors.

### TECHNICAL FIELD

The present invention is generally related to the field of computerized algorithms for managing financial assets, and more particularly to computerized algorithms for managing financial assets secured by municipal leveraged loans.

### BACKGROUND

The global capital markets are fragmented. Significant structuring, underwriting, trading, and origination expertise resides within asset classes, but such expertise almost exclusively projects inwards. The corporate bond world understands little of the municipal bond world and vice-versa.

Such fragmentation is generally institutionalized within the culture of investment banks and other financial asset management institutions. There is little cross asset class interaction with the primary focus being the corporate sector. The municipal market, however, is rapidly evolving with the amount of taxable debt issuance increasing significantly, primarily as a result of the elimination of tax-exempt advance refundings, but also due to other market forces. Expanding the taxable municipal investor base would have a transformative impact on how state and local governments interact with the capital markets.

The corporate bond market is significantly larger than the U.S municipal market. For example, in September of 2019, $434 billion of new corporate bonds were issued around the world, driven primarily by investors in search of yield and corporations having access to low cost money. The market for a certain type of corporate bond known as a “leveraged loan” has grown significantly since the financial crisis, with the amount of US leveraged loans outstanding at the end of 2018 standing at $1.15 trillion. The vast majority of these corporate loans fall into a class known as “covenant lite,” where the loan agreements contain terms that are generally more favorable for borrowers.

However, when the corporate loan market begins to show signs of stress, investors generally flee from corporate leveraged loan funds, creating an immense liquidity in need of alternative taxable investment opportunities. At the same time, US state and local governments need new financing solutions. Many municipal issuers throughout the US maintain significant actuarial deficits in funds, such as pension funds, that they manage on behalf of public employees, meaning that actuarial standards indicate that the current balance within these pension funds are far below what is needed to meet projected future payments to current and future participating pensioners. Thus, there is an opportunity for municipal financial markets to attract investors from the corporate markets.

To address this problem, certain municipal entities have previously incurred debt in the form of publicly sold municipal bonds, the proceeds of which were deposited into their public pension funds to reduce or eliminate the actuarial deficit. Such bonds were referred to as Pension Obligation Bonds (“POBs”).

The original POB performance concept is based on arbitrage. It rests on the assumption that the pension fund manager can use these borrowed monies to achieve a rate of return that is greater than the interest due on the POB. However, this assumption is not always true. In underperforming markets, many issuers had to deposit more money into the pension funds and also had to pay debt service on the bonds, the sum of which was more than if they had not borrowed any money for deposit into their pension funds.

A significant majority of these original POBs (also referred to as “First Generation” POBs hereinafter) were unsuccessful because the underlying pension funds underperformed relative to expectations to such an extent that most issuers no longer consider POBs as a viable option. Embodiments of the present invention address these problems by structuring the obligation as a hedged transaction rather than an arbitrage transaction, where certain risks are passed on to the investors and the rewards are retained by the municipal issuers. Furthermore, in addressing these problems, embodiments of the present invention are structured to attract new investors into the municipal financial markets.

### SUMMARY

At least the above-discussed need is addressed, and technical solutions are achieved in the art by various embodiments of the present invention. Some embodiments of the present invention pertain to systems and methods of managing distribution of income from a portfolio of financial assets.

In some embodiments of the invention, the method is executed by a programmed data processing device system and comprises receiving a debt service payment from the portfolio of financial assets and determining whether a fund benefitted by the portfolio of financial assets meets a target actuarial value. In a case where the fund benefitted by the portfolio of financial assets meets the target actuarial value, the method further includes distributing the debt service payment to one or more investors in the portfolio of financial assets. In a case where the fund benefitted by the portfolio of financial assets does not meet the target actuarial value, the method further includes calculating a deferrable principal payment based on a difference between the target actuarial value of the fund and a present actuarial value of the fund, distributing the deferrable principal payment to the fund benefitted by the portfolio of financial assets, subtracting the deferrable principal amount from the debt service payment to determine a remainder debt service payment, and distributing the remainder debt service payment to the one or more investors in the portfolio of financial assets.

In some embodiments of the invention, the method further includes, after receiving a debt service payment from the portfolio of financial assets and before determining whether a fund benefitted by the portfolio of financial assets meets a target actuarial value, determining whether all financial obligations to the one or more investors in the portfolio of financial assets have been met, and in a case where all financial obligations to the one or more investors in the portfolio of financial assets have been met, distributing the debt service payment to one or more issuers of the portfolio of financial assets.

In some embodiments of the invention, the method further includes, after distributing the debt service payment or the remainder debt service payment to the one or more investors in the portfolio of financial assets, redeeming a financial interest of at least one investor of the one or more investors in the portfolio of financial assets. In some embodiments of the invention, the financial interest of the at least one investor of the one or more investors in the portfolio of financial assets is redeemed in order of seniority of the financial interests of the one or more investors in the portfolio of financial assets.

In some embodiments of the invention, the portfolio of financial assets includes (a) one or more municipal leveraged loans, or (b) one or more corporate leveraged loans, or (c) both (a) and (b).

In some embodiments of the invention, the debt service payment includes an interest payment and a principal payment, and the method further includes distributing the interest payment to the one or more investors irrespective of whether the fund benefitted by the portfolio of financial assets meets the target actuarial value and limiting the deferrable principal payment to the principal payment.

In some embodiments of the invention, the fund benefitted by the portfolio of financial assets is a municipal pension fund. In some embodiments of the invention, the portfolio of financial assets is securitized by one or more revenue streams of one or more issuers of the portfolio of financial assets, and the financial risk associated with the one or more revenue streams is different from the financial risk associated with the fund benefitted by the portfolio of financial assets.

In some embodiments of the invention, the received debt service payment is reduced by an administrative fee payable before any payments are made to either the one or more issuers or the one or more investors of the portfolio of financial assets.

In some embodiments of the invention, the method further includes performing one or more simulations to determine a likelihood that the debt service payment from the portfolio of financial assets will be sufficient to meet all financial obligations owed to the one or more investors in the portfolio of financial assets.

In some embodiments of the invention, a database processing system includes an input-output device system communicatively connected to a display device system, a memory device system storing a program, and a data processing device system communicatively connected to the input-output device system and the memory device system, the data processing device system configured at least by the program at least to perform the methods described above.

### BRIEF DESCRIPTION OF THE DRAWINGS

It is to be understood that the attached drawings are for purposes of illustrating aspects of various embodiments and may include elements that are not to scale. It is noted that like reference characters in different figures refer to the same objects.

FIG. 1 shows a computing device system, according to some embodiments of the invention.

FIG. 2 shows another computing device system, according to some embodiments of the invention.

FIG. 3 shows a system for managing collateralized municipal loan obligations, according to some embodiments of the present invention;

FIG. 4 shows a flowchart for a method of managing collateralized municipal loan obligations, according to some embodiments of the present invention;

FIG. 5 shows a flowchart for a method of determining a principal deflection amount in a system for managing collateralized municipal loan obligations, according to some embodiments of the present invention;

FIG. 6 shows a system for managing collateralized hybrid loan obligations within a same trust, according to some embodiments of the present invention; and

FIG. 7 shows a system for managing collateralized municipal loan obligations within a collection of trusts, according to some embodiments of the present invention.

### DETAILED DESCRIPTION

In some embodiments, the computer systems described herein execute methods for managing collateralized loan obligations. In some embodiments, the loan obligations are municipal loan obligations. In some embodiments, the loan obligations are a mix of municipal and corporate loan obligations. It should be noted that the invention is not limited to these or any other examples provided herein, which are referred to for purposes of illustration only.

In this regard, in the descriptions herein, certain specific details are set forth in order to provide a thorough understanding of various embodiments of the invention. However, one of ordinary skill in the art will understand that the invention may be practiced at a more general level without one or more of these details. In other instances, well-known structures have not been shown or described in detail to avoid unnecessarily obscuring descriptions of various embodiments of the invention.

Any reference throughout this specification to “one embodiment”, “an embodiment”, “an example embodiment”, “an illustrated embodiment”, “a particular embodiment”, “some embodiments” and the like means that a particular feature, structure, or characteristic described in connection with the embodiment is included in at least one embodiment. Thus, any appearance of the phrase “in one embodiment”, “in an embodiment”, “in an example embodiment”, “in this illustrated embodiment”, “in this particular embodiment”, “some embodiments” or the like in this specification is not necessarily all referring to one embodiment or a same embodiment. Furthermore, the particular features, structures or characteristics of different embodiments may be combined in any suitable manner to form one or more other embodiments.

Unless otherwise explicitly noted or required by context, the word “or” is used in this disclosure in a non-exclusive sense. In addition, unless otherwise explicitly noted or required by context, the word “set” is intended to mean one or more. For example, the phrase, “a set of objects” means one or more of the objects.

In the following description, some embodiments of the present invention may be implemented at least in part by a data processing device system configured by a software program. Such a program may equivalently be implemented as multiple programs, and some or all of such software program(s) may be equivalently constructed in hardware.

Further, the phrase “at least” is or may be used herein at times merely to emphasize the possibility that other elements may exist beside those explicitly listed. However, unless otherwise explicitly noted (such as by the use of the term “only”) or required by context, non-usage herein of the phrase “at least” nonetheless includes the possibility that other elements may exist besides those explicitly listed. For example, the phrase, ‘based at least on A’ includes A as well as the possibility of one or more other additional elements besides A. In the same manner, the phrase, ‘based on A’ includes A, as well as the possibility of one or more other additional elements besides A. However, the phrase, ‘based only on A’ includes only A. Similarly, the phrase ‘configured at least to A’ includes a configuration to perform A, as well as the possibility of one or more other additional actions besides A. In the same manner, the phrase ‘configured to A’ includes a configuration to perform A, as well as the possibility of one or more other additional actions besides A. However, the phrase, ‘configured only to A’ means a configuration to perform only A.

The word “device”, the word “machine”, the word “system”, and the phrase “device system” all are intended to include one or more physical devices or sub-devices (e.g., pieces of equipment) that interact to perform one or more functions, regardless of whether such devices or sub-devices are located within a same housing or different housings. However, it may be explicitly specified according to various embodiments that a device or machine or device system resides entirely within a same housing to exclude embodiments where the respective device, machine, system, or device system resides across different housings. The word “device” may equivalently be referred to as a “device system” in some embodiments.

The phrase “derivative thereof” and the like is or may be used herein at times in the context of a derivative of data or information merely to emphasize the possibility that such data or information may be modified or subject to one or more operations. For example, if a device generates first data for display, the process of converting the generated first data into a format capable of being displayed may alter the first data. This altered form of the first data may be considered a derivative of the first data. For instance, the first data may be a one-dimensional array of numbers, but the display of the first data may be a color-coded bar chart representing the numbers in the array. For another example, if the above-mentioned first data is transmitted over a network, the process of converting the first data into a format acceptable for network transmission or understanding by a receiving device may alter the first data. As before, this altered form of the first data may be considered a derivative of the first data. For yet another example, generated first data may undergo a mathematical operation, a scaling, or a combining with other data to generate other data that may be considered derived from the first data. In this regard, it can be seen that data is commonly changing in form or being combined with other data throughout its movement through one or more data processing device systems, and any reference to information or data herein is intended to include these and like changes, regardless of whether or not the phrase “derivative thereof” or the like is used in reference to the information or data, unless otherwise required by context. As indicated above, usage of the phrase “or a derivative thereof” or the like merely emphasizes the possibility of such changes. Accordingly, the addition of or deletion of the phrase “or a derivative thereof” or the like should have no impact on the interpretation of the respective data or information. For example, the above-discussed color-coded bar chart may be considered a derivative of the respective first data or may be considered the respective first data itself.

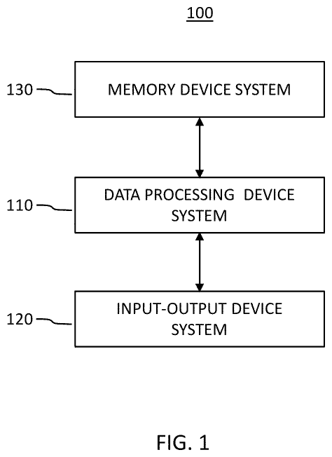

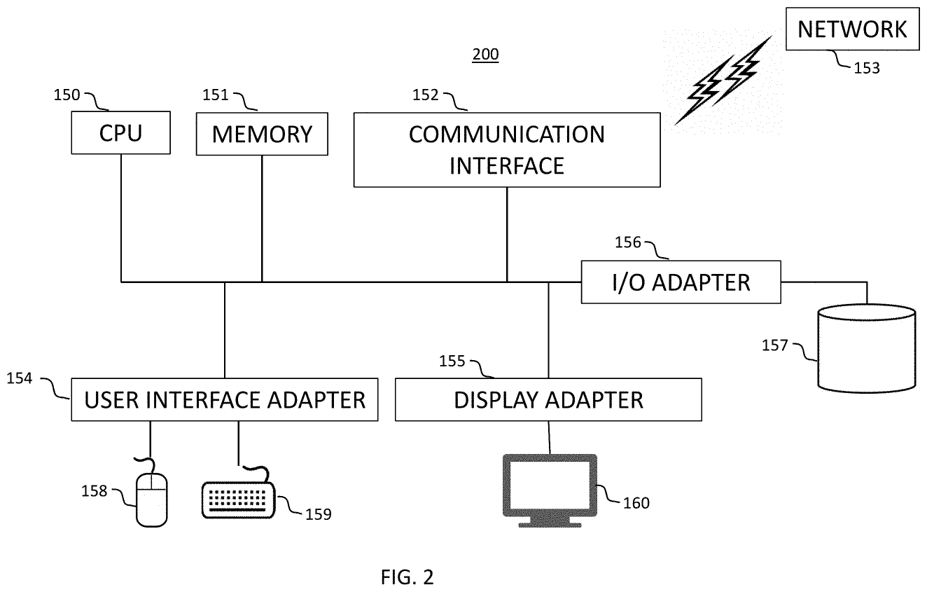

The term “program” in this disclosure should be interpreted to include one or more programs including a set of instructions or modules that may be executed by one or more components in a system, such as a controller system or data processing device system, in order to cause the system to perform one or more operations. The set of instructions or modules may be stored by any kind of memory device, such as those described subsequently with respect to the memory device system 130, 151, or both, shown in FIGS. 1 and 2, respectively. In addition, this disclosure may describe or similarly describe that the instructions or modules of a program are configured to cause the performance of an action. The phrase “configured to” in this context is intended to include at least (a) instructions or modules that are presently in a form executable by one or more data processing devices to cause performance of the action (e.g., in the case where the instructions or modules are in a compiled and unencrypted form ready for execution), and (b) instructions or modules that are presently in a form not executable by the one or more data processing devices, but could be translated into the form executable by the one or more data processing devices to cause performance of the action (e.g., in the case where the instructions or modules are encrypted in a non-executable manner, but through performance of a decryption process, would be translated into a form ready for execution). Such descriptions should be deemed to be equivalent to describing that the instructions or modules are configured to cause the performance of the action. The word “module” may be defined as a set of instructions. The word “program” and the word “module” may each be interpreted to include multiple sub-programs or multiple sub-modules, respectively. In this regard, reference to a program or a module may be considered to refer to multiple programs or multiple modules.

Further, it is understood that information or data may be operated upon, manipulated, or converted into different forms as it moves through various devices or workflows. In this regard, unless otherwise explicitly noted or required by context, it is intended that any reference herein to information or data includes modifications to that information or data. For example, “data X” may be encrypted for transmission, and a reference to “data X” is intended to include both its encrypted and unencrypted forms, unless otherwise required or indicated by context. However, non-usage of the phrase “or a derivative thereof” or the like nonetheless includes derivatives or modifications of information or data just as usage of such a phrase does, as such a phrase, when used, is merely used for emphasis.

Further, the phrase “graphical representation” used herein is intended to include a visual representation presented via a display device system and may include computer-generated text, graphics, animations, or one or more combinations thereof, which may include one or more visual representations originally generated, at least in part, by an image-capture device.

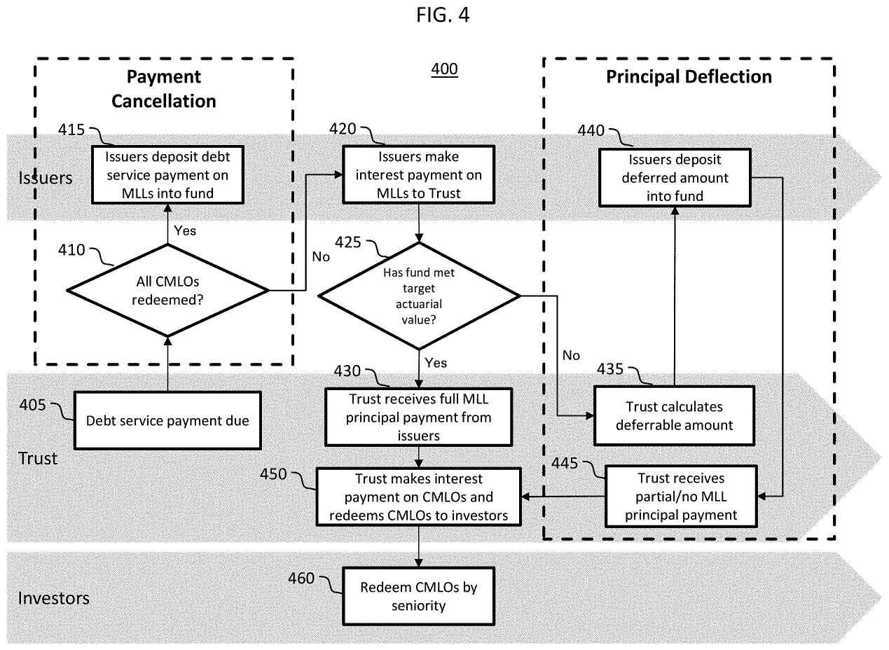

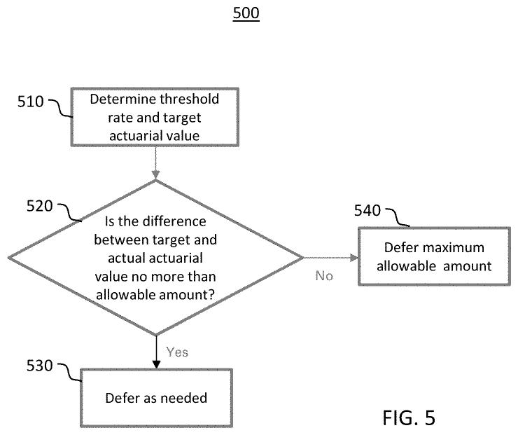

Further still, example methods are described herein with respect to FIGS. 4 and 5. Such figures are described to include blocks associated with computer-executable instructions. It should be noted that the respective instructions associated with any such blocks herein need not be separate instructions and may be combined with other instructions to form a combined instruction set. The same set of instructions may be associated with more than one block. In this regard, the block arrangement shown in method FIGS. 4 and 5 herein is not limited to an actual structure of any program or set of instructions or required ordering of method tasks, and such method FIGS. 4 and 5, according to some embodiments, merely illustrate the tasks that instructions are configured to perform, for example upon execution by a data processing device system in conjunction with interactions with one or more other devices or device systems.

FIG. 1 schematically illustrates a system 100 according to some embodiments. In some embodiments, the system 100 may be a computing device 200 (as shown in FIG. 2). In some embodiments, the system 100 includes a data processing device system 110, an input-output device system 120, and a processor-accessible memory device system 130. The processor-accessible memory device system 130 and the input-output device system 120 are communicatively connected to the data processing device system 110.

The data processing device system 110 includes one or more data processing devices that implement or execute, in conjunction with other devices, such as one or more of those in the system 100, control programs associated with some of the various embodiments. Each of the phrases “data processing device”, “data processor”, “processor”, and “computer” is intended to include any data processing device, such as a central processing unit (“CPU”), a desktop computer, a laptop computer, a mainframe computer, a tablet computer, a personal digital assistant, a cellular phone, and any other device configured to process data, manage data, or handle data, whether implemented with electrical, magnetic, optical, biological components, or other.

The memory device system 130 includes one or more processor-accessible memory devices configured to store information, including the information needed to execute the control programs associated with some of the various embodiments. The memory device system 130 may be a distributed processor-accessible memory device system including multiple processor-accessible memory devices communicatively connected to the data processing device system 110 via a plurality of computers and/or devices. On the other hand, the memory device system 130 need not be a distributed processor-accessible memory system and, consequently, may include one or more processor-accessible memory devices located within a single data processing device.

Each of the phrases “processor-accessible memory” and “processor-accessible memory device” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs (Read-Only Memory), and RAMs (Random Access Memory). In some embodiments, each of the phrases “processor-accessible memory” and “processor-accessible memory device” is intended to include a non-transitory computer-readable storage medium. In some embodiments, the memory device system 130 can be considered a non-transitory computer-readable storage medium system.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the memory device system 130 is shown separately from the data processing device system 110 and the input-output device system 120, one skilled in the art will appreciate that the memory device system 130 may be located completely or partially within the data processing device system 110 or the input-output device system 120. Further in this regard, although the input-output device system 120 is shown separately from the data processing device system 110 and the memory device system 130, one skilled in the art will appreciate that such system may be located completely or partially within the data processing system 110 or the memory device system 130, depending upon the contents of the input-output device system 120. Further still, the data processing device system 110, the input-output device system 120, and the memory device system 130 may be located entirely within the same device or housing or may be separately located, but communicatively connected, among different devices or housings. In the case where the data processing device system 110, the input-output device system 120, and the memory device system 130 are located within the same device, the system 100 of FIG. 1 can be implemented by a single application-specific integrated circuit (ASIC) in some embodiments.

The input-output device system 120 may include a mouse, a keyboard, a touch screen, another computer, or any device or combination of devices from which a desired selection, desired information, instructions, or any other data is input to the data processing device system 110. The input-output device system 120 may include any suitable interface for receiving information, instructions or any data from other devices and systems described in various ones of the embodiments.

The input-output device system 120 also may include an image generating device system, a display device system, a speaker device system, a processor-accessible memory device system, or any device or combination of devices to which information, instructions, or any other data is output from the data processing device system 110. In this regard, if the input-output device system 120 includes a processor-accessible memory device, such memory device may or may not form part or all of the memory device system 130. The input-output device system 120 may include any suitable interface for outputting information, instructions or data to other devices and systems described in various ones of the embodiments. In this regard, the input-output device system may include various other devices or systems described in various embodiments.

FIG. 2 shows an example of a computing device system 200, according to some embodiments. The computing device system 200 may include a processor 150, corresponding to the data processing device system 110 of FIG. 1, in some embodiments. The memory 151, input/output (I/O) adapter 156, and non-transitory storage medium 157 may correspond to the memory device system 130 of FIG. 1, according to some embodiments. The user interface adapter 154, mouse 158, keyboard 159, display adapter 155, and display 160 may correspond to the input-output device system 120 of FIG. 1, according to some embodiments. The computing device 200 may also include a communication interface 152 that connects to a network 153 for communicating with other computing devices 200.

Various methods 400 and 500 may be performed by way of associated computer-executable instructions according to some example embodiments. In various example embodiments, a memory device system (e.g., memory device system 130) is communicatively connected to a data processing device system (e.g., data processing device systems 110, otherwise stated herein as “e.g., 110”) and stores one or more programs executable by the data processing device system to cause the data processing device system to execute various embodiments of methods 400 and 500. In these various embodiments, the one or more programs may include instructions configured to perform, or cause to be performed, various ones of the instructions associated with execution of various embodiments of methods 400 and 500. In some embodiments, methods 400 and 500 may include a subset of the associated blocks or additional blocks than those shown in FIGS. 4 and 5. In some embodiments, methods 400 and 500 may include a different sequence indicated between various ones of the associated blocks shown in FIGS. 4 and 5.

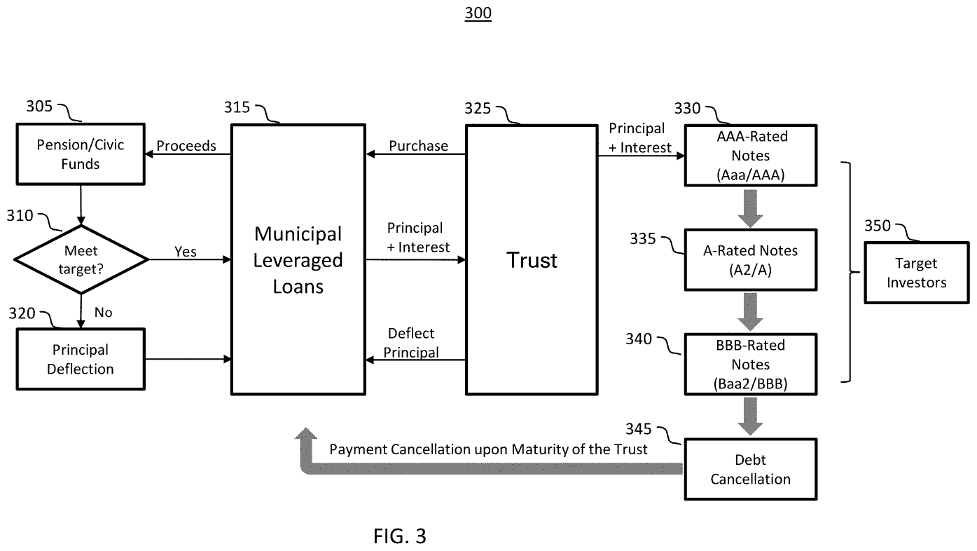

According to some embodiments of the present invention, the system 100 includes some or all of the system 300 shown in FIG. 3, or vice versa. In this regard, FIG. 3 illustrates a collateralized municipal loan obligation (CMLO) system 300, according to some embodiments of the present invention.

CMLOs are municipal financial securities collateralized by a new asset class comprised of Municipal Leveraged Loans (MLLs) 315. For example, the Municipal Securities Rulemaking Board defines municipal securities as “a general term referring to a bond, note, warrant, certificate of participation or other obligation issued by a state or local government or their agencies or authorities (such as cities, towns, villages, counties or special districts or authorities).” However, for purposes of this disclosure, the term municipal securities also includes securities issued by not-for-profit entities such as universities, cultural organizations such as museums, and health care institutions such as hospitals, nursing homes, and assisted living facilities. These not-for-profit entities are an integral part of the municipal capital markets because their bonds can qualify for the federal tax exemption. In this regard, any issuing entity that qualifies for federal tax exemption may be considered a “municipal issuer” for the purposes of this disclosure.

In contrast to municipal securities, the term corporate bond or corporate security refers to bonds issued by for-profit companies or corporations.

In some embodiments of the invention, one or more tranches of CMLOs 330, 335, 340 are created as marketable securities that are either rated by a nationally recognized financial securities rating agency or unrated. The cash flows due to CMLO investors 350 are derived from the financial obligations due from a pledged pool of MLLs 315 placed in a financial trust 325 for the benefit of CMLO investors 350. Some embodiments of the invention provide systems and methods of electronically performing cash flow analyses to test the sufficiency of the financial obligations due from the MLLs 315 to meet the cash flow obligations due to CMLO investors 350. In some embodiments of the invention, the cash flow analyses incorporate MLL default risk and the risks associated with potential MLL repayment retention related to the MLL issuers' pension or other designated fund 305 performance. To assess the aforementioned risks, the systems and methods may utilize statistically rigorous Monte Carlo simulations for each performance scenario.

In the examples (Example 1 and Example 2) discussed below, the cash flows are generated based on fixed interest rates (on MLLs & CMLOs), pre-determined target pension fund actuarial value (threshold rate) and actual issuer's pension fund performance (variable). However, the invention is not limited to cash flows based on fixed interest rates and the interest rate may be variable in some embodiments of the invention. Further, the target pension fund actuarial value does not need to be pre-determined, which means that, in some embodiments, the threshold rate may be a floating rate.

This structure can divert both interest and principal payment received from the underlying collateral to the senior notes to junior notes. In some embodiments of the invention, Monte Carlo simulations may be performed to determine the likelihood that a CMLO can fully amortize (pay off investors) by maturity under different pension fund performances.

Monte Carlo methods are based on an analogy between probability and volume or measure of an event relative to a universe of possible outcomes. As an example, a Monte Carlo simulation may be performed by sampling randomly from the universe of possible outcomes and taking the fraction of random draws that fall within a given set (satisfy a constraint) as n estimate of the set's volume. The law of large numbers ensures that this estimate converges to the correct value as the number of draws increases. The details of various Monte Carlo simulation methods are well known in the art and are omitted here. In some embodiments, pension fund performance (also can be other index or fund) is simulated using Monte Carlo methods, based on aggregated weighted pension funds (or other or index fund) historical data to determine whether the trust can fully pay off investors at end of maturity. The aggregated weighted pension fund performance data may be obtained from the weighted average of all the participating pension funds.

By running a large number of simulations, the likelihood that the “trust will experience default” can be fairly estimated. In some embodiments of the invention, the interest rate on the MLLs is expected to fully amortize the CMLOs; therefore, there wouldn't be any CMLO default no matter how the pension fund performed in the future, as long as the trust receives interest payment on MLLs as scheduled.

A CMLO system designed to benefit municipal pension funds can be constructed to include a Second Generation POB, which utilizes the novel and inventive features and structures of the CMLO system to address the drawbacks of First Generation POBs. Although the embodiments of the CMLO system described herein are structured to benefit a pension fund, it should be obvious to one of ordinary skill in the art that other types of municipal obligation bonds could be included in a CMLO system, benefiting other municipal or community funds besides pension funds. Thus, the claims are not limited to CMLO systems that include POBs and encompass any type of municipal fund.

Embodiments of the invention recognize that purposing MLLs to address pension fund actuarial deficits can serve as a vehicle to achieve the previously described objective of drawing new classes of investors into the municipal market for three primary reasons. First, POBs are issued on a taxable basis. Second, pension fund deficits across the US are large enough to generate transaction sizes that would be of interest to corporate bond and other investors that have not historically participated in the municipal financial markets. Third, POBs can be pooled to create structured asset classes familiar to leveraged loan investors that are also beneficial to municipal issuers.

POBs are not new to the municipal market and issuers have originated a significant number of First Generation POBs. Such bonds have been promoted as a way for issuers to generate an arbitrage spread between their taxable borrowing rate and the rate expected to be earned in the pension fund. State and local governments deposited proceeds from First Generation POBs into municipal pension funds to reduce or eliminate actuarial deficits in these funds. First Generation POBs were typically fixed rate bonds secured by the issuer's highest rated credit in order to minimize borrowing cost. First Generation POBs were perceived as arbitrage transactions where the invested proceeds would obviate the need to make annuity payments into the fund. But these transactions achieved the desired benefit only when the debt service on the POBs was lower than the annuities they would have had to make to achieve the desired actuarial value.

As an example (Example 1), consider the following scenario demonstrating basic mechanics for a First Generation POB assuming that bond proceeds fund $1 billion of Unfunded Accrued Actuarial Value (UAAL) and that the assumed pension fund earnings rate is 7.00%. Under this bonding scenario, the actuarial value of the original $1 billion of funding at the end of the twenty year period assuming semi-annual compounding at 7.00% equals $3.959 billion. An alternative to bonding for the $1 billion of UAAL is to make semi-annual deposits into the pension fund. The semi-annual deposit required to generate an equivalent $3.959 billion of actuarial value after twenty years assuming 7.00% earnings is $46.827 million. This level semi-annual payment defines the base case constraint against which the debt service of a POB can be compared in order to determine savings potential. That is, if the issuer could borrow below 7.00%, the semi-annual debt service on the bonds would be less than the semi-annual payments that the issuer would have to deposit into the pension fund in order to achieve the targeted future actuarial value thus resulting in savings to the issuer. (For instance, if the issuer could borrow at 5.00%, the required semi-annual bond payments would be $39.836 million for projected savings of approximately $14 million per year).

However, because the factors on which the UAAL is based are constantly changing (such as mortality and investment return), the final amount of interest rate savings cannot be determined with certainty. Thus, the primary risk associated with the First Generation POBs was that if actual investment rates fell below the expected rate, the issuer would have to pay the debt service on the bonds as well as the increase in the UAAL resulting from lower than expected investment income.

As another example (Example 2) of a First Generation POB where the borrowing cost exceeds the investment performance, consider the following scenario. The pension fund has a semi-annual period 1 ending actuarial balance of $1 million. The actuarial target investment rate is 6%. The manager of the fund has 2 choices, make the $1 million payment at the end of the semi-annual period or borrow at the beginning of the period at a rate of 5%. The required proceeds at a 6% target investment rate are $970,873.78 ($1,000,000,000/1.03). The debt service on the POB's at 5% is $995,145.62 ($1,000,000,000/1.025). However, if the fund underperforms and only returns 4%, the period 1 ending value is $990,291.26 ($970,873.78 *1.02), resulting in a shortfall of $9,708.74. Thus, when the fund underperforms, the manager of the fund now has to make a payment equal to the debt service ($995,145.62) plus the shortfall ($9,708.74) totaling $1,004,854.26, which is greater than the dollar 1 million payment the manager would have had to make if he did not borrow at the beginning of the period.

Based on historical data, a significant majority of municipal pension funds appear to have underperformed relative to expectations to such an extent that most issuers no longer consider these original POBs as a viable option. Embodiments of the present invention address these problems by structuring the obligation as a hedged transaction rather than an arbitrage transaction. Take, for example, the sample semi-annual leveraging constraint (representing for purposes of this analysis the debt service requirement) of $46.827 million set forth in Example 1 under a scenario where, after two years, the targeted actuarial value is $2 million underfunded relative to projections due to weaker than expected investment earnings.

In this scenario in Example 1, the total liability to the issuer is the debt service due bond holders plus the additional $2 million in UAAL. Under the Second Generation POB structure enabled by the CMLO system, as set forth in various embodiments of the present invention, the issuer's semi-annual obligation is fixed at $46.827 million but any shortfall relative to the targeted actuarial value is funded first out of this payment with only the balance then flowing to investors. So, in Example 1, in year 2, of the $46.827 million in required issuer payments, $2 million is deflected from investors and deposited into the pension fund to maintain the targeted actuarial value and investors receive $44.827 million.

Under this scenario the issuer is not defaulting on the $2 million of principal but is instead deferring principal amortization. The CMLO system permits structuring fixed payment Second Generation POBs to significantly increase the probability that the issuer will achieve the targeted future actuarial value thereby eliminating the core risk associated with the First Generation POBs.

Returning back to the scenario set forth in Example 2 above, instead of making a total payment of $1,004,854.26 (debt service plus shortfall) at the end of the period, the Second Generation POB structure permits the manager to segregate the amount due to the trust ($995,145.62) into a principal of $970,873.78 and interest due of $24,271,84. The shortfall of $9,708.74 is deflected back from the principal to be deposited into the fund by subtracting it from payments made by the issuers. Thus, instead of paying $995,145.62 to the investors, the issuers pay only $985,436.88 (adjusted principal of $970,873.78 and interest of $24,271,84). In this scenario, the ending fund value at period 1 is $970,873.78 (principal portion) plus $19,417.48 (earnings at 4.00%) plus $9,708.74 (principal deflection), totaling $1,000,000. In other words, when the fund underperforms, the manager is not left holding the risk of having to pay more than the regular deposit without borrowing.

Another feature of the CMLO system is the bifurcation of risk. In conventional financial security portfolios, the performance risk is directly related to the performance characteristics of the pledged assets. For example, in mortgage backed-bonds, the pledged assets are the underlying mortgages. The credit risk for mortgage backed-bonds arises from the mortgagees' inability to make mortgage payments. The performance risk arises from the ability of borrowers to prepay their mortgage which creates amortization uncertainty. Thus, both the credit risk and the performance risk lie within the pledged collateral. Similarly, in tobacco revenue bonds, the credit risk arises from the inability or unwillingness of tobacco companies to make payments due under the global settlement agreements with states and the performance risk arises from varying tobacco product consumption.

Second Generation POBs, as implemented according to some embodiments of the present invention, bifurcate the credit risk from the performance risk. In the examples discussed here, the performance risk in the CMLO system arises from varying pension fund earnings. But the MLLs are not backed by pensions funds. Rather, the MLLs are securitized by other revenue streams, such as tax revenues, of the municipal bond issuers. Thus, the credit risk is more independent of the performance risk in Second Generation POBs.

The CMLO system 300 may be a particular implementation of the system 100 implemented on a computing device 200, according to some embodiments. The CMLO system 300 may include a collateralized pool of municipal leveraged loans 315 issued by municipal or civic authorities, placed in a trust 325, that services municipal or civic funds (such as pension funds) 305 through proceeds from investors 350.

The CMLO system 300 differs from a conventional corporate bond based Collateralized Loan Obligation (CLO) system. In typical CLO systems, a corporate structure is set up to purchase corporate bonds, place them in the trust, process debt payments received from corporations, pay expenses of the trust, and then pay CLO investors in accordance with class priority. The cash flow of a CLO is typically one way only, from borrowers to investors. Its logic is based on two dimensions, the CLO sponsors manage payments from the collateral pool and distribute those payments to the CLO investors. All payments due the CLO from the securitized collateral are due in full through maturity. The collateral pool is created by purchasing sufficient corporate bonds that meet core rating criteria. Risk within the context of a CLO pool of collateral is evaluated in terms of concentration risk, sector risk, and recovery risk. Concentration risk depends on how much of the collateral pool is related to one borrower or groups of borrowers (less concentration typically results in stronger credit). Sector risk depends on how much of the collateral pool is related to one industry sector (transportation, energy, hospitality, as examples). More diversity in sectors typically results in stronger credit. Recovery risk depends on, upon default, the likelihood that all or a portion of the amounts due can be recovered through the bankruptcy process.

CLOs typically create a pool of “covenant-lite leveraged loans,” which are generally below investment grade loans but are on parity or senior to all other obligations of the corporation so that they are assigned a high recovery rate by the rating agencies.

By spreading risks across a significant number of borrowers that are diversified across industry sectors with a strong probability for recovery, the CLO creator can achieve a credit spread, meaning that it can purchase the underlying collateral based on their individual junk bond rating and sell them at a higher price in the form of a tranched set of CLOs.

In contrast to the CLOs described above, the CMLOs described in various embodiments of the present invention have a very different structure. CMLO cash flows are multi-dimension, which includes MLLs 315, investors 350 and one or more civic funds 305. The cash flows within the CMLO system are bilateral meaning that either by principal deferral or debt cancellation, MLL payments are subject to return to MLL issuers. In CMLOs, the collateralized pool of municipal leveraged loans 315 comprises municipal bonds having subordinate lien pledges, senior lien pledges, or a mix thereof. In some embodiments of the invention, the municipal bonds are issued directly into the trust 325 rather than obtained as secondary seasoned market bonds. In some embodiments of the invention, the municipal leveraged loans are not actively managed; the collateralized pool of bonds forming the municipal leveraged loans 315 is static in that the trust 325 does not buy and sell these bonds as loans 315 in and out of the trust 325 in order to maintain certain diversity or rating covenants.

CLOs typically incorporate a ramp-up period during which they use their own or borrowed capital to acquire the collateral pool. In some embodiments of the invention, in contrast to CLOs, the trust 325 of CMLOs is created using new municipal bonds issued by municipal or civic authorities and placed directly into the trust 325.

While a typical CMLO trust 325 may appear to have higher concentration risk than CLOs (fewer municipal or civic authorities issuing municipal bonds versus more corporations issuing corporate bonds) and higher sector risk than CLOs (municipal revenue versus corporations spanning a large breadth of industries), the full diversity of the issuing municipal or civic authority's broad economy can dramatically lower the actual concentration risk and sector risk. For example, a city may manage a number of revenue bond credits including sales tax, water and sewer, surface transportation, air transportation, etc. Collectively, these revenue streams capture the full diversity of the city's broad economy, thereby reducing sector risk. Similarly, there are a large number of companies across all industry sectors utilizing city assets that generate the revenue streams. Every commercial enterprise in the city collects sales tax, almost every commercial enterprise is impacted by city transportation controls. The spread of the city's revenue streams across the entire breadth of the city's commercial enterprise reduces the concentration risk.

The recovery risk in a CMLO is very different from a recovery risk in a CLO. For a corporate bond, the negative result of a distressed credit is typically very binary. The corporate bond issuer makes its full payment until it no longer is able to do so, in which case it defaults and no payment is made until the bankruptcy proceeds are resolved or a workout is negotiated.

Default/recovery in an MLL is non binary: failure to make the full amount of payment due is not considered a default. In other words, given the revenue bond credits governing even the subordinate debt, historical performance indicates that the probability that a civic or municipal issuer would not be able to make their full payment is relatively small. Further, absent a total destruction of the underlying asset that generates the revenue stream securitizing the MLL (an earthquake destroys a toll bridge, for instance) historical performance indicates that the CMLO trust 325 would still expect to receive a significant portion of the payment due.

Another key difference between a CLO and a CMLO is the ownership of trust residuals. In a typical CLO, any collateral receipts due the trust after full amortization of the CLOs are owned by the trust (or sold off in advance as a high yield equity tranche). In some embodiments of the invention, in a CMLO, payments due the trust 325 after full amortization of the CMLOs are retained by the issuers. That is, the trust 325 will only collect MLL payments during the time that any CMLO obligations to the investors remain outstanding. In some embodiments of the invention, the issuers may deposit all or some of the retained payments into the pension or other municipal fund benefited by the trust (or the pool of MLLs forming the trust). In some embodiments of the invention, the trust may charge an administrative fee, which may be collected from the MLL payments.

The CMLO system 300 shown in FIG. 3 illustrates a trust 325 structured such that the issuers receive the full benefit of any credit spread achieved. Such benefit manifests within the architecture of the CMLO system 300 in the form of a principal deflection mechanism 320 and a debt cancellation mechanism 345.

As a result, the trust 325 functions as a “pass-through” structure in the sense that the trust 325 receives debt service payments (principal+interest) from the MLLs 315, subject to the principal deflection mechanism 320, and passes them through to CMLO investors 350 who invest in different CMLO tranches 330, 335, and 340. Once the CMLO investors are paid off (redeemed), the trust 325 winds down and any remaining debt service payments are retained by the issuers of the MLLs 315 through the debt cancellation mechanism 345..

In some embodiments of the invention, the CMLO system 300 includes pension or civic funds 305 that characterize the performance risk of the system. The pension or civic funds 305 have actuarial targets defining the amount of periodic deposits (proceeds) made into the funds 305 by investors 350 purchasing the CMLOs. The principal deflection mechanism 320 is activated when a target determination mechanism 310 determines that the pension or civic fund 305 has not met its actuarial target. When the principal deflection mechanism 320 is activated, some or a portion of the principal included in the debt service payment from the MLLs 315 is retained by the issuers instead of being deposited in the trust 325. In some embodiments of the invention, the deflected principal is deposited by the issuers of the MLLs 315 into the pension or civic fund 305 to reduce or eliminate the shortfall in the fund 305 because the actuarial target was not met.

In some embodiments of the invention, the trust 325 bundles various MLLs 315 into various tranches of CMLOs having different credit ratings. As illustrative examples only, the CMLO tranches may include AAA-rated notes 330, A-rated notes 335, and BBB-rated notes 340, among others.

In some embodiments of the invention, the investors 350 are redeemed in seniority of the rating of the CMLO tranches. For example, AAA-rated notes 330 may be redeemed before A-rated notes 335, with BBB-rated notes 340 being redeemed last.

In some embodiments of the invention, if all CMLOs are redeemed prior to the maturity of the trust 325, meaning there are still debt service payments due from the MLLs 315, a debt cancellation mechanism 345 is activated to permit the issuers of the MLLs 315 to retain the remaining debt service payments, thereby benefiting the municipal or civic authorities that are the issuers of the MLLs 315 rather than the investors 350.

In some embodiments of the invention, the trust 325 may charge an administrative fee to manage the CMLOs or to prematurely wind down the trust 325 if the debt cancellation mechanism is activated. In some embodiments of the system, the administrative fee may be subtracted from the principal and interest received from the MLLs 315 prior to paying the interest to the investors or redeeming the CMLOs.

FIG. 4 is a high-level flowchart of a method 400 of managing a CMLO system 300. In some embodiments of the invention, the method 400 is executed periodically when a debt service payment is due (step 405). In step 410, the status of CMLO redemption is checked. If all CMLOs have been redeemed (Yes to step 410), then the debt cancellation mechanism kicks in and the trust is wound down. In step 415, because of the debt cancellation, the issuers retain the debt service payment that was due (from step 405) or, preferably, deposit the debt service payment into the fund that is benefited by the CMLO system. If all CMLOs have not been redeemed (No to step 410), then, in step 420, the interest portion of the debt service payment is deposited into the trust for payout to the investors.

In some embodiments of the invention, in step 425, it is determined whether the fund that is benefited by the CMLO system has met its target actuarial value for the preceding period. If the fund has met its target actuarial value (Yes to step 425), then, in step 430, the principal portion of the debt service payment is deposited into the trust for payout to the investors. In step 450, the trust makes interest payment on outstanding CMLOs to the investors and uses the remaining debt service payment to redeem CMLOs to investors. In step 460, the investors redeem CMLOs based on their redemption seniority.

If the fund has not met its target actuarial value (No to step 425), then, in some embodiments of the invention, the principal deflection mechanism is activated. In step 435, the trust calculates the deferrable principal amount based on a difference between the target actuarial value of the fund and the actual actuarial value of the fund. In step 440, a portion of the principal of the debt service payment, corresponding to the deferrable principal amount, is deflected back to the issuers for deposit into the fund benefited by the CMLO system. In step 445, the remaining portion of the principal of the debt service payment, after subtracting the deferrable principal amount, is deposited into the trust. Thereafter, similar to the case where the trust receives the full principal portion of the debt service payment (step 430), in step 450, the trust makes interest payment on outstanding CMLOs to the investors and uses the remaining portion of the debt service payment from issuers to redeem CMLOs to investors.

FIG. 5 is a high-level flowchart of a method 500 of determining the deferrable principal amount, according to some embodiments of the invention. In some embodiments of the invention, the method 500 provides further details for step 435 of method 400. In step 510, the target actuarial value and the threshold rate required to achieve the target actuarial value are determined. In some embodiments of the invention, the threshold rate and the target actuarial values are predetermined in advance when the trust 325 is created. In step 520, the difference between the target actuarial value and the actual actuarial value is computed and compared with a maximum allowable deferrable principal amount. In some embodiments of the invention, the maximum allowable deferrable principal amount corresponds to the principal portion of the debt service payment due from the MLLs 315 during that period. In some embodiments of the invention, the maximum allowable deferrable principal amount may be set at a predetermined amount lower than the principal portion of the debt service payment due during that period.

If the difference between the target and actual actuarial value is not more than the maximum allowable deferrable principal amount (Yes to step 520), then, in step 530, the difference between the target and actual actuarial value is set as the deferrable principal amount to be deflected back to the issuers. If the difference between the target and actual actuarial value is more than the maximum allowable deferrable principal amount (No to step 520), then, in step 540, the maximum allowable deferrable principal amount is set as the deferrable principal amount to be deflected back to the issuers.

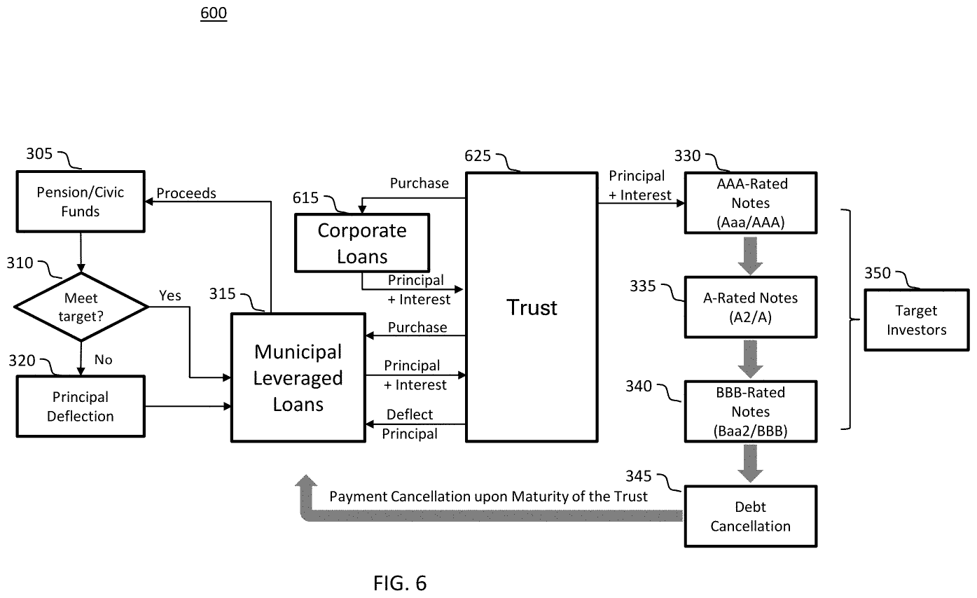

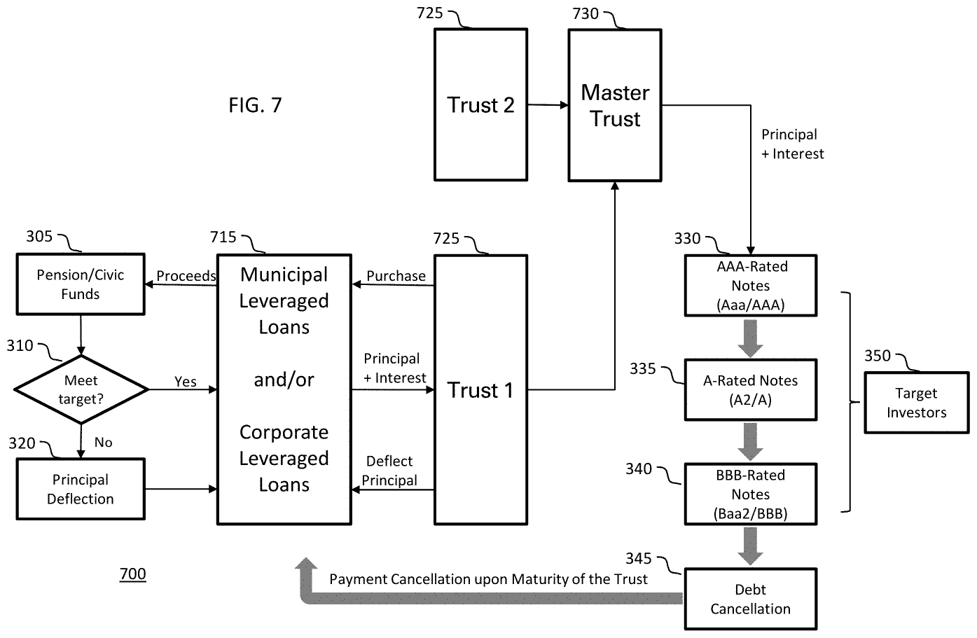

FIGS. 6 and 7 show other embodiments of the invention, where a mix of municipal and corporate securities may be managed as a hybrid CMLO/CLO trust, or as a collection of CMLO and CLO trusts. It should be noted that the embodiments of FIGS. 6 and 7 provide illustrative example of “mixed” security structures, and on of ordinary skill in the art could structure a trust in different forms to include a mix of both municipal and corporate securities.

FIG. 6 shows an example embodiment of a hybrid CMLO/CLO system 600 that includes a hybrid trust 625 formed using both MLLs 315 and corporate bonds/securities 615. In some embodiments of the invention, one or both of the principal deflection mechanism 320 and the debt cancellation mechanism 345 may apply only to the MLLs 315. Elements of the hybrid CMLO/CLO system 600 having a same reference number as elements of the CMLO system 300 operate in a similar manner, and a description of these elements is not repeated here for purposes of brevity.

It should be noted that the principal deflection mechanism 320 and the debt cancellation mechanism 345 are not limited to the MLLs 315 within the hybrid trust 625, and may be applied to the corporate loans 615 in some embodiments of the invention.

FIG. 7 shows another example embodiment of a hybrid CMLO/CLO system 700 that includes a master trust 730, which includes two or more trusts 725. Each of the trust 725 may be a CMLO trust, a CLO trust, or a hybrid trust as discussed with regard to FIG. 6. In some embodiments of the invention, one or both of the principal deflection mechanism 320 and the debt cancellation mechanism 345 may apply only to MLLs included in the two or more trusts 725. Elements of the hybrid CMLO/CLO system 700 having a same reference number as elements of the CMLO system 300 operate in a similar manner, and a description of these elements is not repeated here for purposes of brevity.

It should be noted that the principal deflection mechanism 320 and the debt cancellation mechanism 345 are not limited to the MLLs within the trusts 725, and may be applied to the corporate loans in some embodiments of the invention.

Subsets or combinations of various embodiments described above provide further embodiments.

These and other changes can be made to the invention in light of the above-detailed description and still fall within the scope of the present invention. In general, in the following claims, the terms used should not be construed to limit the invention to the specific embodiments disclosed in the specification. Accordingly, the invention is not limited by the disclosure, but instead its scope is to be determined entirely by the following claims.

1. A method of managing distribution of income from a portfolio of financial assets, the method executed by a programmed data processing device system, the method comprising:
receiving a debt service payment from the portfolio of financial assets;
determining whether a fund benefitted by the portfolio of financial assets meets a target actuarial value;
in a case where the fund benefitted by the portfolio of financial assets meets the target actuarial value, distributing the debt service payment to one or more investors in the portfolio of financial assets; and
in a case where the fund benefitted by the portfolio of financial assets does not meet the target actuarial value:
calculating a deferrable principal payment based on a difference between the target actuarial value of the fund and a present actuarial value of the fund;
distributing the deferrable principal payment to the fund benefitted by the portfolio of financial assets;
subtracting the deferrable principal amount from the debt service payment to determine a remainder debt service payment; and
distributing the remainder debt service payment to the one or more investors in the portfolio of financial assets.

2. The method according to claim 1, further comprising, after receiving a debt service payment from the portfolio of financial assets and before determining whether a fund benefitted by the portfolio of financial assets meets a target actuarial value:
determining whether all financial obligations to the one or more investors in the portfolio of financial assets have been met; and
in a case where all financial obligations to the one or more investors in the portfolio of financial assets have been met, distributing the debt service payment to one or more issuers of the portfolio of financial assets.

3. The method according to claim 1, further comprising, after distributing the debt service payment or the remainder debt service payment to the one or more investors in the portfolio of financial assets, redeeming a financial interest of at least one investor of the one or more investors in the portfolio of financial assets.

4. The method according to claim 3, wherein the financial interest of the at least one investor of the one or more investors in the portfolio of financial assets is redeemed in order of seniority of the financial interests of the one or more investors in the portfolio of financial assets.

5. The method according to claim 1, wherein the portfolio of financial assets includes (a) one or more municipal leveraged loans, or (b) one or more corporate leveraged loans, or (c) both (a) and (b).

6. The method according to claim 1,
wherein the debt service payment includes an interest payment and a principal payment, and
wherein the method further comprises:
distributing the interest payment to the one or more investors irrespective of whether the fund benefitted by the portfolio of financial assets meets the target actuarial value; and
limiting the deferrable principal payment to the principal payment.

7. The method according to claim 1, wherein the fund benefitted by the portfolio of financial assets is a municipal pension fund.

8. The method according to claim 1,
wherein the portfolio of financial assets is securitized by one or more revenue streams of one or more issuers of the portfolio of financial assets, and
wherein the financial risk associated with the one or more revenue streams is different from the financial risk associated with the fund benefitted by the portfolio of financial assets.

9. The method according to claim 1, wherein the received debt service payment is reduced by an administrative fee payable before any payments are made to either the one or more issuers or the one or more investors of the portfolio of financial assets.

10. The method according to claim 1, further comprising performing one or more simulations to determine a likelihood that the debt service payment from the portfolio of financial assets will be sufficient to meet all financial obligations owed to the one or more investors in the portfolio of financial assets.

11. A database processing system comprising:
an input-output device system communicatively connected to a display device system;
a memory device system storing a program; and
a data processing device system communicatively connected to the input-output device system and the memory device system, the data processing device system configured at least by the program at least to:
receive a debt service payment from the portfolio of financial assets;
determine whether a fund benefitted by the portfolio of financial assets meets a target actuarial value;
in a case where the fund benefitted by the portfolio of financial assets meets the target actuarial value, distribute the debt service payment to one or more investors in the portfolio of financial assets; and
in a case where the fund benefitted by the portfolio of financial assets does not meet the target actuarial value:
calculate a deferrable principal payment based on a difference between the target actuarial value of the fund and a present actuarial value of the fund;
distribute the deferrable principal payment to the fund benefitted by the portfolio of financial assets;
subtract the deferrable principal amount from the debt service payment to determine a remainder debt service payment; and
distribute the remainder debt service payment to the one or more investors in the portfolio of financial assets.

12. The database processing system according to claim 11, wherein the data processing device system is further configured at least by the program to, after receiving a debt service payment from the portfolio of financial assets and before determining whether a fund benefitted by the portfolio of financial assets meets a target actuarial value:
determine whether all financial obligations to the one or more investors in the portfolio of financial assets have been met; and
in a case where all financial obligations to the one or more investors in the portfolio of financial assets have been met, distribute the debt service payment to one or more issuers of the portfolio of financial assets.

13. The database processing system according to claim 11, wherein the data processing device system is further configured at least by the program to, after distributing the debt service payment or the remainder debt service payment to the one or more investors in the portfolio of financial assets, redeem a financial interest of at least one investor of the one or more investors in the portfolio of financial assets.

14. The database processing system according to claim 11, wherein the financial interest of the at least one investor of the one or more investors in the portfolio of financial assets is redeemed in order of seniority of the financial interests of the one or more investors in the portfolio of financial assets.

15. The database processing system according to claim 11, wherein the portfolio of financial assets includes (a) one or more municipal leveraged loans, or (b) one or more corporate leveraged loans, or (c) both (a) and (b).

16. The database processing system according to claim 11,
wherein the debt service payment includes an interest payment and a principal payment, and
wherein the data processing device system is further configured at least by the program to:
distribute the interest payment to the one or more investors irrespective of whether the fund benefitted by the portfolio of financial assets meets the target actuarial value; and
limit the deferrable principal payment to the principal payment.

17. The database processing system according to claim 11, wherein the fund benefitted by the portfolio of financial assets is a municipal pension fund.

18. The database processing system according to claim 11,
wherein the portfolio of financial assets is securitized by one or more revenue streams of one or more issuers of the portfolio of financial assets, and
wherein the financial risk associated with the one or more revenue streams is different from the financial risk associated with the fund benefitted by the portfolio of financial assets.

19. The database processing system according to claim 11, wherein the received debt service payment is reduced by an administrative fee payable before any payments are made to either the one or more issuers or the one or more investors of the portfolio of financial assets.

20. The database processing system according to claim 11, wherein the data processing device system is further configured at least by the program to perform one or more simulations to determine a likelihood that the debt service payment from the portfolio of financial assets will be sufficient to meet all financial obligations owed to the one or more investors in the portfolio of financial assets.

21. A method of managing distribution of income from a portfolio of financial assets, the method executed by a programmed data processing device system, the method comprising:
receiving a debt service payment from the portfolio of financial assets;
determining whether all financial obligations to one or more investors in the portfolio of financial assets have been met;
in a case where all financial obligations to the one or more investors in the portfolio of financial assets have been met, distributing the debt service payment to one or more issuers of the portfolio of financial assets; and
in a case where all financial obligations to the one or more investors in the portfolio of financial assets have not been met, distributing the debt service payment to the one or more investors in the portfolio of financial assets.

22. The method according to claim 21, further comprising, after receiving a debt service payment from the portfolio of financial assets and before determining whether all financial obligations to one or more investors in the portfolio of financial assets have been met:
determining whether a fund benefitted by the portfolio of financial assets meets a target actuarial value;
in a case where the fund benefitted by the portfolio of financial assets does not meet the target actuarial value:
calculating a deferrable principal payment based on a difference between the target actuarial value of the fund and a present actuarial value of the fund;
distributing the deferrable principal payment to the fund benefitted by the portfolio of financial assets; and
subtracting the deferrable principal amount from the debt service payment.

23. A database processing system comprising:
an input-output device system communicatively connected to a display device system;
a memory device system storing a program; and
a data processing device system communicatively connected to the input-output device system and the memory device system, the data processing device system configured at least by the program at least to:
receive a debt service payment from the portfolio of financial assets;
determine whether all financial obligations to one or more investors in the portfolio of financial assets have been met;
in a case where all financial obligations to the one or more investors in the portfolio of financial assets have been met, distribute the debt service payment to one or more issuers of the portfolio of financial assets; and
in a case where all financial obligations to the one or more investors in the portfolio of financial assets have not been met, distribute the debt service payment to the one or more investors in the portfolio of financial assets.

24. The database processing system according to claim 23, wherein the data processing device system is further configured at least by the program to, after receiving a debt service payment from the portfolio of financial assets and before determining whether all financial obligations to one or more investors in the portfolio of financial assets have been met:
determine whether a fund benefitted by the portfolio of financial assets meets a target actuarial value;
in a case where the fund benefitted by the portfolio of financial assets does not meet the target actuarial value:
calculate a deferrable principal payment based on a difference between the target actuarial value of the fund and a present actuarial value of the fund;
distribute the deferrable principal payment to the fund benefitted by the portfolio of financial assets; and
subtracting the deferrable principal amount from the debt service payment.
